(19) United States
(12) Patent Application Publication
(10) Pub. No.: US 2011/0138019 A1
(43) Pub. Date: Jun. 9, 2011

(54) SYSTEM AND METHOD FOR PROVIDING MULTI-LAYERED CONTENT USING PLURALITY OF SERVERS

(75) Inventors: Seong-Jun BAE, Daejeon (KR); Jung Won KANG, Seoul (KR); Jeong Ju YOO, Daejeon (KR); Won RYU, Daejeon (KR)

(73) Assignee: Electronics and Telecommunications Research Institute, Daejeon (KR)

(21) Appl. No.: 12/964,076

(22) Filed: Dec. 9, 2010

(30) Foreign Application Priority Data
Dec. 9, 2009 (KR) 10-2009-0122032

(51) Int. Cl. G06F 15/16

(52) U.S. Cl. 709/219; 709/246; 709/227

(57) ABSTRACT

Provided is a system and method for providing a multi-layered content that may divide a content encoded using a scalable coding scheme, into a plurality of quality groups having different quality levels, assign corresponding servers to the plurality of quality groups, and transmitting the quality groups, increasing a number of transmission sessions.

### CROSS-REFERENCE TO RELATED APPLICATION

This application claims the benefit of Korean Patent Application No. 10-2009-0122032, filed on Dec. 9, 2009, in the Korean Intellectual Property Office, the disclosure of which is incorporated herein by reference.

### BACKGROUND

1. Field of the Invention

The present invention relates to a system and method for providing a multi-layered content, and more particularly, to a system and method for providing a content using a plurality of servers.

2. Description of the Related Art

An on-demand type of a contents service such as a video on demand (VOD) service, an audio on demand (AOD) service, and the like may generate an independent content transmission session between a server and a user equipment in order to transmit a corresponding content from at least one server storing the content to a user equipment desiring the content. The content may be transmitted through the generated independent content transmission session. Through this, a contents service of readily controlling contents may be provided to a plurality of user equipments. For example, a content control may include a play, a stop, and a random access in a content play location.

A server for providing an on-demand service may separately configure a number of transmission sessions corresponding to a number of user equipments requesting a content transmission with respect to each of contents. Here, a number of sessions that can be simultaneously serviceable at a single server may be limited based on a server resource. The server resource may represent all the types of resources required by a server in order to provide a contents transmission service. For example, the server resource may include a processing capacity of a corresponding server and a bandwidth of an output side of the server.

Also, a coding rate of the server resource may be in inverse proportion to a coding rate of the content. Accordingly, a number of sessions simultaneously serviceable at the server may increase according to a decrease in a coding rate of a service target content. Similarly, the number of sessions simultaneously serviceable at the server may decrease according to an increase in the coding rate of the service target content. Accordingly, when a content having a relatively low coding rate is to be transmitted, a single server may provide a relatively large number of service sessions.

However, a coding rate of a high quality content is higher than a coding rate of a low quality content. Accordingly, as a screen quality or a sound quality of a content is enhanced, the number of sessions simultaneously serviceable at the single server may decrease. Here, the high quality may include the high screen quality or the high sound quality.

Accordingly, there is a desire for a content providing method that may increase a number of serviceable transmission sessions even though a high quality content is transmitted.

### SUMMARY

According to an aspect of the present invention, there is provided a method of providing a multi-layered content, the method including: encoding content using a scalable coding scheme; and dividing the encoded content into a plurality of quality groups having different quality levels.

The encoding may include encoding the content to a multi-layered structure including the plurality of quality levels, and the dividing may include dividing the content into the plurality of quality groups having the multi-layered structure by grouping the plurality of quality levels.

The plurality of quality groups may be transmitted via a plurality of servers, respectively.

The method may further include: assigning a plurality of server groups having a multi-layered structure in order to transmit the plurality of quality groups; and determining whether to use a non-assigned server group including a plurality of non-assigned servers, based on a number of user equipments being serviced by each of the server groups and an amount of resources used by each of the server groups.

According to another aspect of the present invention, there is provided a method of receiving a multi-layered content, the method including: establishing a session with each of a plurality of servers corresponding to a plurality of quality groups having different quality levels; and receiving the plurality of quality groups corresponding to the plurality of servers with the established session.

The plurality of quality groups may be included in a content encoded using a scalable coding scheme.

According to still another aspect of the present invention, there is provided a user equipment including: a sub-layer receiving unit to receive a plurality of quality groups having different quality levels using a plurality of servers corresponding to the plurality of quality groups; a sub-layer synchronizer to reconfigure a content in a multi-layered structure by combining the plurality of quality groups; and a decoder to decode the reconfigured content, and to output the decoded content.

According to embodiments of the present invention, it is possible to provide a relatively large number of transmission sessions using the same number of servers by dividing a single content into a plurality of quality groups having different quality levels and thereby transmitting the divided content.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure of a content encoded using a scalable coding scheme according to an embodiment of the present invention;

FIG. 2 is a flowchart illustrating a method of distributing and transmitting a content in a multi-layered structure using a plurality of servers according to an embodiment of the present invention;

FIG. 3 is a diagram to describe a method of distributing and transmitting a content of a multi-layered structure using a plurality of servers according to an embodiment of the present invention;

FIG. 4 is a flowchart illustrating a method of using, by server groups of a multi-layered structure, a non-assigned server group according to an embodiment of the present invention;

FIG. 5 is a diagram illustrating a configuration of entire server groups for operating server groups in a multi-layered structure according to an embodiment of the present invention; and

FIG. 6 is a diagram illustrating a configuration of a user equipment receiving a content of a multi-layered structure having different quality levels according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be shortened or omitted here.

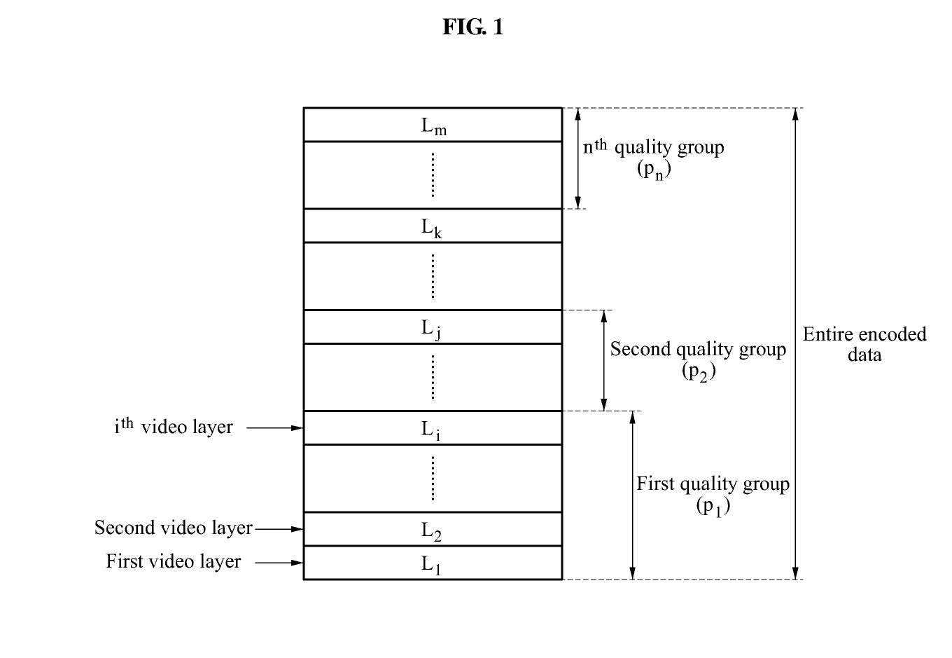

FIG. 1 is a diagram illustrating a structure of a content encoded using a scalable coding scheme according to an embodiment of the present invention.

Referring to FIG. 1, the content encoded using the scalable coding scheme may have a multi-layered structure including different quality levels. Here, a quality may indicate a sound quality or a screen quality of the content.

For example, the encoded content may have the multi-layered structure including m quality levels. Specifically, the encoded content may include a first video layer L₁ to an m^{th} video layer Lₘ.

In this instance, a lower layer may be used to reproduce an upper layer. The upper layer may have a relatively enhanced screen quality or sound quality compared to the lower layer. For example, the first video layer L₁ to an (i−1)^{th} video layer Lᵢ₋₁ may be used to reproduce a quality level of an i^{th} video layer Lᵢ. The content may be divided into a plurality of quality groups by grouping layers having different quality levels.

More specifically, as shown in FIG. 1, the encoded content including m quality levels may include n quality groups. That is, the encoded content may include a first quality group p₁ to an n^{th} quality group pₙ. Through this, the content having different n screen quality levels or sound quality levels may be provided to a user equipment. A relatively enhanced quality may be provided to a quality group in an order from the first quality group p₁ to the n^{th} quality group pₙ.

For example, a lowest quality level may correspond to a quality level when the first quality group p₁ is received, and a second lowest quality level may correspond to a quality level when all of the first quality group p₁ and the second quality group p₂ are received. A highest quality level may correspond to a quality level when all of the first quality group p₁ to the n^{th} quality group pₙ are received. Accordingly, a relatively enhanced quality may be provided in an order from a lower quality group to an upper quality group. The upper quality group may include quality levels of lower quality groups of the corresponding upper quality group.

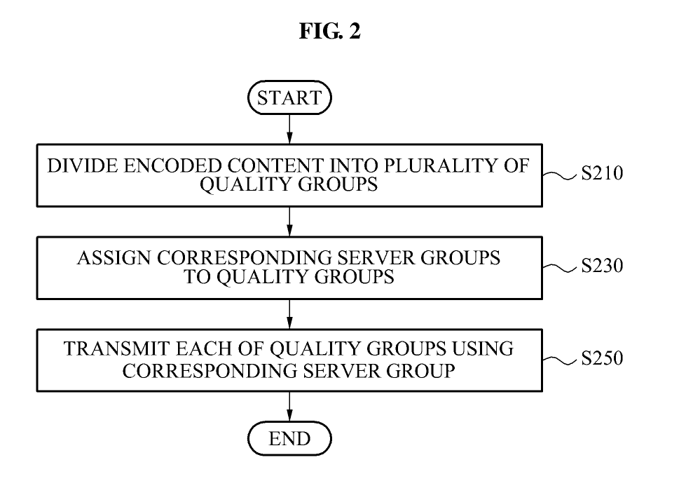

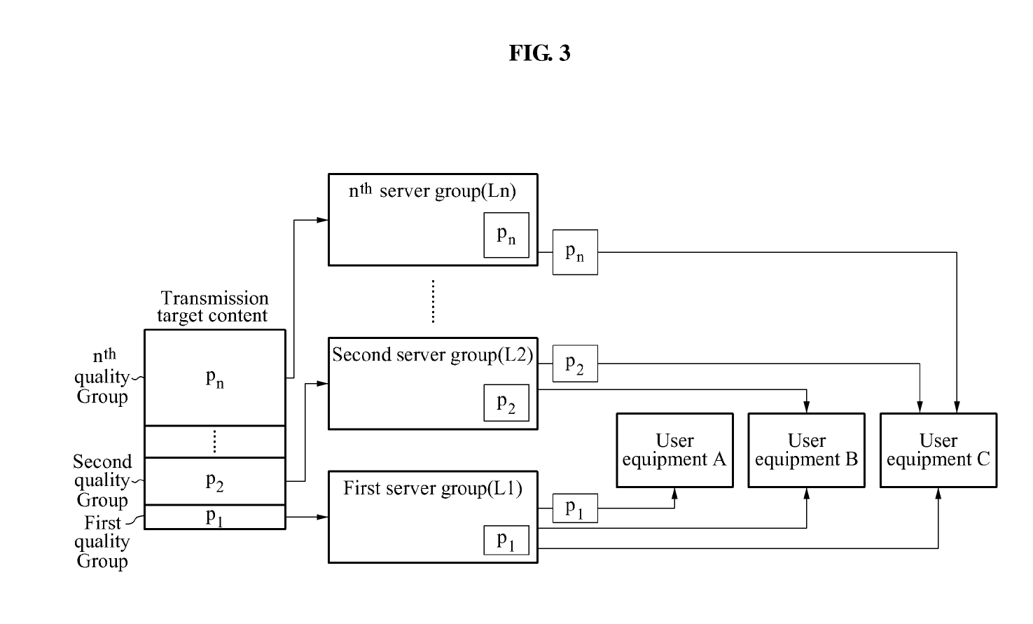

FIG. 2 is a flowchart illustrating a method of distributing and transmitting a content of a multi-layered structure using a plurality of servers according to an embodiment of the present invention, and FIG. 3 is a diagram to describe a method of distributing and transmitting a content of a multi-layered structure using a plurality of servers according to an embodiment of the present invention.

Referring to FIG. 2 and FIG. 3, in operation S210, a content encoded using a scalable coding scheme may be divided into a plurality of quality groups having different quality levels. For example, as shown in FIG. 3, the encoded content may have the multi-layered structure including a first quality group p₁ to an n^{th} quality group pₙ.

In operation S230, a content providing system may assign a server group to each of the plurality of quality groups. For example, a first server group L1 to an n^{th} server group Ln may be assigned to the first quality group p₁ to the n^{th} quality group pₙ, in order to transmit the plurality of quality groups.

In operation S250, each of the server groups may transmit a corresponding quality group to each of user equipments. For example, the first server group L1 to the n^{th} server group Ln may transmit the first quality group p₁ to the n^{th} quality group pₙ to each of user equipments A, B, and C. Each of the user equipments A, B, and C may receive the content having a different quality level.

As one example, referring to FIG. 3, when the first server group L1 including a plurality of first servers is assigned to transmit the first quality group p₁ and the user equipment A has a lowest service level, the user equipment A may receive, from the first server group L1, the first quality group p₁ corresponding to a lowest quality level.

As another example, when the second server group L2 including a plurality of second servers is assigned to transmit the second quality group p₂ and the user equipment B has a second lowest service level higher than the user equipment A, the user equipment B may receive the first quality group p₁ and the second quality group p₂ from the first server group L2 and the second server group L2 in order to receive a content corresponding to a second lowest quality level.

Using the same method, the user equipment C may receive the first quality group p₁ to the n^{th} quality group pₙ from the first server group L1 to the n^{th} server group Ln in order to receive the content having a highest quality level. Through this, the content may be provided by optimally adjusting a number of servers included in a server group based on a number of user equipments for each quality group. Here, each quality group may have a different bitrate.

As one example, an upper quality group having a relatively high quality level may have a relatively high bitrate compared to a lower quality group of the corresponding upper quality group. That is, a quality group closer to pₙ may have a relatively high bitrate. Accordingly, by transmitting, using corresponding server groups, a plurality of quality groups divided based on a quality level, it is possible to increase only a number of servers corresponding to a quality group requesting a high resource, and to maintain a number of servers corresponding to a quality group requesting a low resource.

Specifically, it is possible to increase a number of servers included in a server group corresponding to an upper quality group having a relatively small number of sessions that can be processed at a single server, and to maintain a number of servers included in a server group corresponding to a lower quality group. Accordingly, it is possible to more effectively provide contents using a relatively small number of servers.

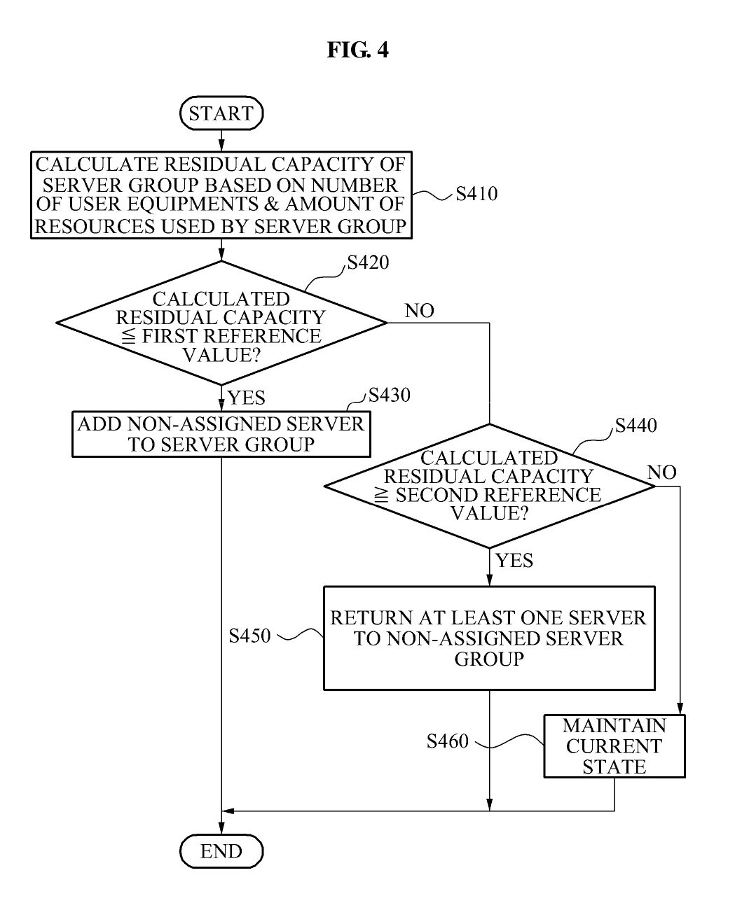

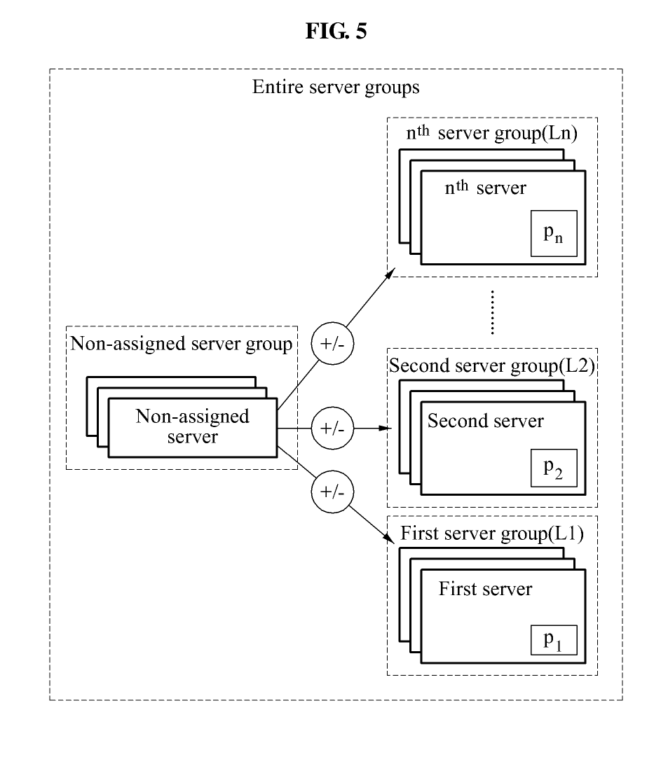

FIG. 4 is a flowchart illustrating a method of using, by server groups of a multi-layered structure, a non-assigned server group according to an embodiment of the present invention, and FIG. 5 is a diagram illustrating a configuration of entire server groups for operating server groups in a multi-layered structure according to an embodiment of the present invention.

Referring to FIG. 4 and FIG. 5, in operation 5410, one of a plurality of servers included in a server group may calculate a residual capacity of the server group based on an amount of resources used by the server group.

More specifically, referring to FIG. 5, the entire server groups may include a non-assigned server group to which the content is not assigned, and a first server group L1 to an n^{th} server group Ln that are respectively assigned to a first quality group p₁ to an n^{th} quality group pₙ based on a quality level. The non-assigned server group may include a plurality of non-assigned servers, and each of the first server group L1 to the n^{th} server group Ln may include a plurality of servers.

One server among a plurality of servers included in a single server group may calculate a residual capacity based on a number of user equipments being serviced at a corresponding server group including the server, and an amount of resources used by the server group.

More specifically, one server among the plurality of servers included in the server group may calculate the residual capacity of the corresponding server group based on an amount of resources used by each of servers. Referring to FIG. 5, a residual capacity may be calculated with respect to each of the first server group L1 to the n^{th} server group Ln.

When the calculated residual capacity is less than or equal to a first reference value in operation S420, one of the servers included in the server group may add, to the corresponding server group, at least one of non-assigned servers included in the non-assigned server group in operation S430. Here, the first reference value may be pre-set as a real number value to add the non-assigned server to the server group. At least one non-assigned server may be added to the server group based on the calculated residual capacity or the difference between the residual capacity and the first reference value, which may vary depending on embodiments.

When the calculated residual capacity is greater than the first reference value in operation S420, one of the servers included in the server group may compare the residual capacity with a second reference value in operation S440. The second reference value may be pre-set as a real number value to return, to the non-assigned server group, servers included in the server group.

More specifically, when the residual capacity is greater than or equal to the second reference value in operation S440, one of the servers included in the server group may return, to the non-assigned server group, at least one of the servers included in the corresponding server group including the server in operation S450.

Here, one of the server groups included in the server group may calculate a residual capacity of each of servers included in the server group, and may return, to the non-assigned server group, at least one server having a marginal residual capacity. In this example, the residual capacity of the server may be calculated using the same method as operation S430. Also, at least one of servers included in the server group may be returned to the non-assigned server group based on the calculated residual capacity or the difference between the residual capacity and the second reference value, which may vary depending on embodiments.

As described above, through operations S430 and S450, it is possible to provide an optimal number of server groups with respect to a transmission session with user equipments being currently serviced and a content quality level of the transmission session. Accordingly, a number of transmission sessions with user equipments simultaneously provided in the entire server groups may increase.

Conversely, when the residual capacity is less than the second reference value in operation S440, one of the servers included in the server group may maintain a current state of the corresponding server group in operation S460. Specifically, the number of servers included in the server group may not be changed and may be maintained as is.

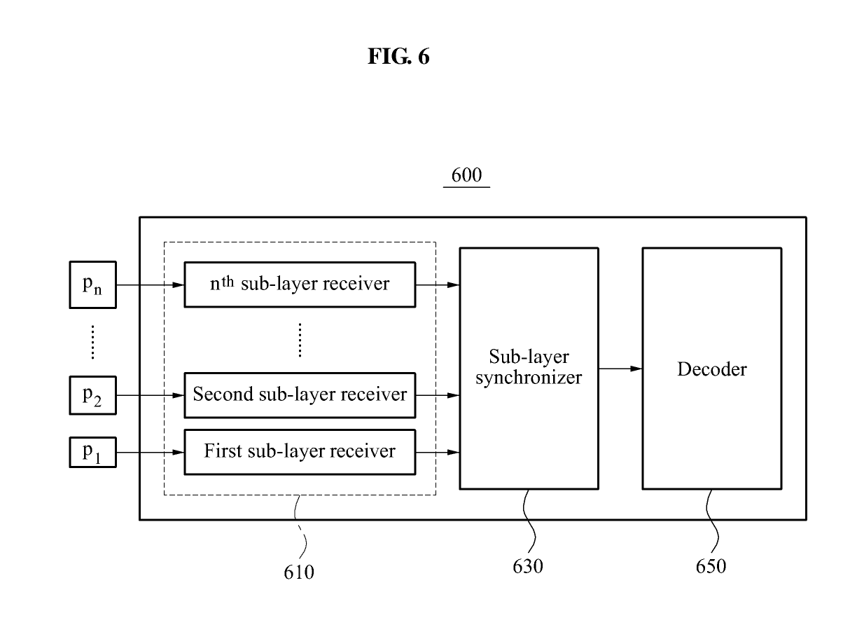

FIG. 6 is a diagram illustrating a configuration of a user equipment 600 receiving a content of a multi-layered structure having different quality levels according to an embodiment of the present invention.

Referring to FIG. 6, the user equipment 600 may include a sub-layer receiving unit 610, a sub-layer synchronizer 630, and a decoder 650.

The sub-layer receiving unit 610 may sequentially receive a plurality of quality groups, for example, p₁ to pₙ having different quality levels from a plurality of server groups corresponding to the plurality of quality groups.

The sub-layer receiving unit 610 may include a first sub-layer receiver to an n^{th} sub-layer receiver in order to receive the plurality of quality groups, for example, p₁ to pₙ.

The sub-layer receiving unit 610 may establish a session with each of the server groups to receive the plurality of quality groups.

Specifically, the sub-layer receiving unit 610 may establish the session with each of the server groups in an order from a server group corresponding to a lower quality group to a server group corresponding to an upper quality group among the plurality of quality groups.

The sub-layer receiving unit 610 may receive the plurality of quality groups in an order from a server group corresponding to a lower quality group established with the session to a server group corresponding to an upper quality group. Referring to FIG. 1, the lower quality group may indicate a quality group, for example, p₁ having a relatively low quality level. The upper quality group may indicate a quality group, for example, pₙ having a relatively high quality level.

The sub-layer synchronizer 630 may reconfigure the content by combining the plurality of quality groups received for each quality level using the first sub-layer receiver to the n^{th} sub-layer receiver.

In this instance, the sub-layer synchronizer 630 may reconfigure the content by combining, in an interpretable order of the decoder 650, the quality groups received in an asynchronous state using the first sub-layer receiver to the n^{th} sub-layer receiver. The reconfigured content may be a content encoded using a salable coding scheme by the content providing system.

The decoder 650 may decode the reconfigured content and output the decoded content using a display or a speaker.

As described above with reference to FIG. 4, even though different servers independently transmit contents using the sub-layer receiving unit 610 and the sub-layer synchronizer 630, the user equipment 600 may reconfigure the contents into a single content.

When a transmission session is established between the user equipment 600 and each of servers, the single user equipment 600 may manage established transmission sessions at one time. Accordingly, the user equipment 600 may reconfigure the content of the multi-layer structure from quality groups received based on quality levels.

When comparing the residual capacity with the first reference value and the second reference value, expressions “less than or equal” and “greater than or equal” are used. However, they are only examples and thus, the comparison may be performed using “less than” and “greater than”.

In addition, an example of adding a non-assigned server to a server group using the first reference value and the second reference value, or returning, to the non-assigned server, a server included in a server group is described. However, it is only an example and thus, when adding the non-assigned server to the server group, or returning, to the non-assigned server, the server included in the server group, only a single reference value may be used. Specifically, the first reference value may be equal to the second reference value.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing a multi-layered content, the method comprising
encoding content using a scalable coding scheme; and
dividing the encoded content into a plurality of quality groups having different quality levels.

2. The method of claim 1, wherein:
the encoding comprises encoding the content to a multi-layered structure including the plurality of quality levels, and
the dividing comprises dividing the content into the plurality of quality groups having the multi-layered structure by grouping the plurality of quality levels.

3. The method of claim 1, wherein the plurality of quality groups is transmitted via a plurality of servers, respectively.

4. The method of claim 1, further comprising:
assigning a plurality of server groups having a multi-layered structure in order to transmit the plurality of quality groups; and
determining whether to use a non-assigned server group including a plurality of non-assigned servers, based on a number of user equipments being serviced by each of the server groups and an amount of resources used by each of the server groups.

5. The method of claim 4, wherein the determining comprises:
calculating a residual capacity of each of the server groups based on the number of user equipments and the amount of resources; and
adding a non-assigned server to at least one of the assigned server groups or returning at least one of assigned servers included in the plurality of assigned server groups by comparing the calculated residual capacity with a predetermined reference value.

6. The method of claim 4, wherein the assigning comprises assigning a plurality of subgroups to have the multi-layered structure including quality levels corresponding to the plurality of quality groups.

7. The method of claim 1, wherein each of the quality groups provides a different bitrate based on a different quality level.

8. The method of claim 1, wherein the quality comprises a screen quality or a sound quality of the content.

9. A method of receiving a multi-layered content, the method comprising:
establishing a session with each of a plurality of servers corresponding to a plurality of quality groups having different quality levels; and
receiving the plurality of quality groups corresponding to the plurality of servers with the established session,
wherein the plurality of quality groups are included in a content encoded using a scalable coding scheme.

10. The method of claim 9, wherein the receiving comprises receiving, using the plurality of servers, the single content comprising the plurality of quality groups.

11. The method of claim 9, further comprising:
reconfiguring the content encoded using the scalable coding scheme by combining the plurality of quality groups.

12. The method of claim 11, further comprising:
decoding the reconfigured content and outputting the decoded content using a display or a speaker.

13. The method of claim 9, wherein the establishing comprises establishing the session in an order from a server group corresponding to a lower server group having a relatively low quality level to a server group corresponding to an upper server group having a relatively high quality level among the plurality of quality groups.

14. A user equipment comprising:
a sub-layer receiving unit to receive a plurality of quality groups having different quality levels using a plurality of servers corresponding to the plurality of quality groups;
a sub-layer synchronizer to reconfigure a content in a multi-layered structure by combining the plurality of quality groups; and
a decoder to decode the reconfigured content, and to output the decoded content.

15. The user equipment of claim 14, wherein the sub-layer receiving unit comprises:
a plurality of sub-layer receivers to correspond to the plurality of servers and to receive the plurality of quality groups.

16. The user equipment of claim 14, wherein the sub-layer receiving unit sequentially receives the plurality of quality groups using the plurality of servers based on the quality levels of the quality groups.

17. The user equipment of claim 16, wherein the sub-layer receiving unit receives the plurality of quality groups using the plurality of servers in an order from a server corresponding to a lower quality group having a relatively low quality level to a server corresponding to a high quality group having a relatively high quality level among the plurality of quality groups.
